(19) United States
(12) Patent Application Publication
(10) Pub. No.: US 2012/0158556 A1
(43) Pub. Date: Jun. 21, 2012

(54) Dynamic Measurement Of Business Service Usage

(76) Inventors: Bare Said, (US); Stefan Baeuerle, (US)

(21) Appl. No.: 12/973,795

(22) Filed: Dec. 20, 2010

(51) Int. Cl. G06Q 10/00; G06Q 30/00

(52) U.S. Cl. 705/30; 705/1.1

(57) ABSTRACT

Upon receiving a service call relating to completion of a business process that uses resources of a core software platform, a service meta-object comprising a business value calculation blueprint associated with the service call can be retrieved from a metadata repository. The business value calculation blueprint can include an algorithm for assigning a business value to the service call. The algorithm can include a specification of required input data about the service call. The required input data can be extracted from at least one of the service call and an application component from which the service call originated. The business value can be calculated based on the extracted required data and the business value calculation blueprint. Related methods, systems, and articles of manufacture are disclosed.

### TECHNICAL FIELD

The subject matter described herein relates to dynamically measuring business service usage, for example in business software architectures.

### BACKGROUND

Various organizations make use of enterprise resource planning (ERP) software architectures to provide an integrated, computer-based system for management of internal and external resources, such as for example tangible assets, financial resources, materials, customer relationships, and human resources. In general, an ERP software architecture is designed to facilitate the flow of information between business functions inside the boundaries of the organization and manage the connections to outside service providers, stakeholders, and the like. Such architectures often include one or more centralized databases accessible by a core software platform that consolidates business operations, including but not limited to those provided by third party vendors, into a uniform and organization-wide system environment. The core software platform can reside on a centralized server or alternatively be distributed across modular hardware and software units that provide “services” and communicate on a local area network or over a network, such as for example the Internet, a wide area network, a local area network, or the like.

A core software platform of an ERP software architecture or other business or other types of software can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible. Smaller organizations can also benefit from use of ERP functionality. However, such an organization may lack the necessary hardware resources, IT support, and/or consulting budget necessary to make use of a standalone ERP software architecture product and can in some cases be more effectively served by a software as a service (SaaS) arrangement in which the ERP system architecture is hosted on computing hardware such as servers and data repositories that are maintained remotely from the organization's location and accessed by authorized users at the organization via a thin client, such as for example a web browser, over a network.

### SUMMARY

In one aspect, a completer-implemented method includes receiving a service call relating to completion of a business process. Satisfaction of the service call includes use of resources of a core software platform. A service meta-object that includes a business value calculation blueprint associated with the service call is retrieved from a metadata repository. The business value calculation blueprint includes an algorithm for assigning a business value to the service call. The algorithm includes a specification of required input data about the service call. The required input data is extracted from at least one of the service call and an application component from which the service call originated, and the business value is calculated based on the extracted required data and the business value calculation blueprint. The calculated business value is then promoted.

In some variations one or more of the following can optionally be included. The core software platform can include a multi-tenant architecture that includes an application server providing access for each of a plurality of organizations to at least one of a plurality of client tenants each being configured to provide isolated access to a customizable instance of the core software platform and a data repository. The data repository can include core software platform content common to all of the plurality of client tenants and relating to operation of the core software platform, system content having a system content format defined by the core software platform and containing system content data that are unique to specific client tenants of the plurality of client tenants, and tenant-specific content items whose tenant-specific content formats and tenant-specific content data are defined by and available to only one of the plurality of client tenants. The service call can be initiated by a tenant of the plurality of tenant, and the promoting can include generating an aggregated business value use by the tenant by adding the business value of the service call to other business values of other service calls originating from the tenant during a billing period. A subscription price for the billing period to be paid by the organization for which the tenant provides isolated access to the customizable instance of the core software platform can be assigned by comparing the aggregated business value to a use-based subscription fee structure. The promoting can include generating and reporting an aggregated business value use rate by each tenant of the plurality of tenants based on the business value of the service call and the business value of all other service calls during a time period. The application server can include a plurality of server machines to which a plurality of incoming service calls from the plurality of tenants are distributed by a load balancer. An algorithm for distributing the incoming service calls can be determined based on the aggregated business value use rate by each tenant of the plurality of tenants. The service meta-object can further include a usage and logging blueprint defining usage data to log in regards to the service call. Dynamic usage and invocation of the resources of the core software platform in satisfying the service call can be documented.

Articles are also described that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

The subject matter described herein provides many advantages. Improved, more flexible strategies for revenue/customer cost models can be based on actual system resource usage instead of simply on a number of users at a customer organization. Additionally, market driven development and optimizations of application features can be based on usage information of customer systems.

The details of one or more variations of the subject matter described herein are set forth in the accompanying drawings and the description below. It should be noted that, while the descriptions of specific implementations of the current subject matter discuss delivery of enterprise resource planning software to multiple organizations via a multi-tenant system, the current subject matter is applicable to other types of software and data services access as well. The scope of the subject matter claimed below therefore should not be limited except by the actual language of the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a system architecture diagram illustrating types calls to services of core software platform;

FIG. 2 is a process flow diagram illustrating aspects of a method consistent with implementations of the current subject matter;

FIG. 3 is a system architecture diagram illustrating tracking of service calls in a software architecture;

FIG. 4 is a call sequence chart illustrating tracking of service calls in a software architecture;

FIG. 5 is a system architecture diagram illustrating tracking of service calls and their associated business value in a software architecture;

FIG. 6 is a table illustrating structure of a business object service meta-object;

FIG. 7 is a table showing an example of a business object service meta-object associated with a sales order service call;

FIG. 8 is a call sequence chart illustrating tracking of service calls in a software architecture;

FIG. 9 is a diagram showing an example of a multi-tenant approach to providing customized software services to multiple organizations from a single architecture; and

FIG. 10 is a diagram showing storage of both core software package data objects and tenant-specific data objects for each of multiple tenants of a multi-tenant system.

When practical, similar reference numbers denote similar structures, features, or elements.

### DETAILED DESCRIPTION

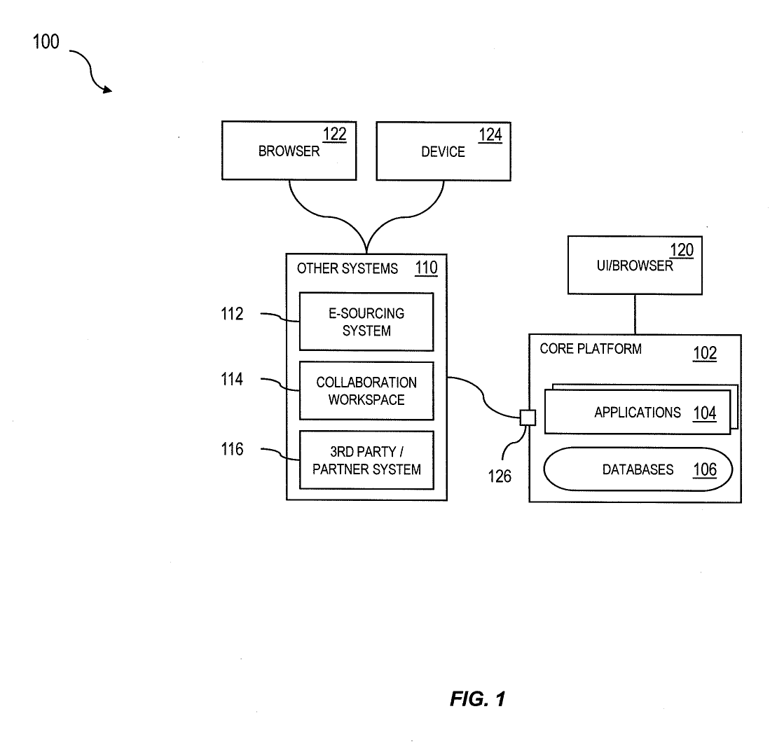

A typical SaaS offering can include a user-based monthly subscription fee that is bound to the number of users and/or to the application scope used. Illustrative examples of scope can include a full feature set available from an ERP suite, customer relationship management (CRM) only, etc. In an overall system landscape, for example the configuration 100 shown in FIG. 1, other types of software components can be connected to a core platform 102, such as for example an ERP system that includes one or more core applications 104 accessing one or more databases 106. Examples of external systems 110 can include specific eSourcing systems 112, collaboration programs 114, third party systems 116 such as payroll and the like, etc. The core platform can be accessed via a first user interface 120, such as a browser, etc. via a named user logon. Similarly, the external systems 110 can be accessed via a named user logon via a system-specific user interface accessed via a browser 122, device 124, or the like. The external systems 110 can also access the core platform, for example via a web services interface 126 in which the true end-user is not necessarily known to the core platform. For integration of the core platform 102 with one or more external systems 110, it is not necessary from a technical point of view that every user on an external system is known to the core system. The technical integration can also be done via technical service users.

Information about the types of users supported by a core platform 102 of a software architecture and the actual level of activity and/or usage of software system services by those users can be important for determining more intelligent pricing as well as allocation of physical system resources such as processor cores, memory, storage, and the like. Such information, which currently available software architectures are generally not configured to provide, can be very helpful in offering a user subscription model that can include metrics related to the overall system usage from a business service perspective rather than simply based on a number of users per customer.

To address these and potentially other issues with currently available solutions, one or more implementations of the current subject matter provide methods, systems, articles or manufacture, and the like that can, among other possible advantages, provide automated, detailed, and relevant data regarding actually system resource usage by customers of a software offering. An improved understanding of how services of a software architecture are used by customers and a richer information set about the most used business services and communication channels can facilitate offering of more representative pricing options as well as improved focusing of development, hardware, etc. resources on the most heavily used business service and technology features.

System usage can be measured in a number of ways. A first order approach can use volume-based measures related to a number of service calls made during a measurement period. For example, a the number of Web service calls (e.g. a number of received messages) can be measured by counting the calls. Based on the number of calls received, the system usage can be identified. Alternatively, a volume-based measure can be related to the data volume of calls received during a measurement period. Rather than relying on a number of calls received, this approach focuses on the data volume of service calls, for example a total number of kilobytes transferred, sent, stored in a database or other storage, etc. during a measurement period. In this manner, all service calls are not considered to be equal—those requiring retrieval of a larger amount of data are more expensive from a service usage standpoint.

Implementations of the current subject matter can also track additional information related to the provided business value of a service call. For example, one or more pattern recognition algorithms can determine a business value-based measure related to a given service call. When a service is called, the business value provided by leveraging and invoking this service can be calculated. This business value calculation can be based on a comprehensive understanding of the business semantic of the called service and the business context of the service call, for example by incorporating analytical value based measures related to a service call. The business semantic of a called service can be defined in a service meta-object as discussed in greater detail below.

As an illustrative example, a web service interface can be used by an external consumer for creation of a sales order instance within a software architecture. A first call of this interface can involve a sales order containing one item while a second call of the interface can involve a second sales order containing 1000 items. A call based service usage approach would weight both calls the same way as each is counted as one call. Such an approach can be useful in scenarios for which a large amount of service calls is expected and the data volume required for each call is almost similar. Using a data volume based approach, the two calls would be weighted differently. Response to the second call requires accessing a larger number of items and therefore a greater volume of data than the first call. Therefore, the second call would have a higher service usage weight associated with it. Such an approach can be useful in scenarios for which the number of messages is expected to be lower but each message contains data volumes that are expected to vary substantially. Use of pattern analysis to calculate a business value of each service call would weight the two calls in a third manner, with the second service call having a higher weight than the first service call because of the greater business value associated with 1000 items than with one item. In some examples, the 1000 items can refer to different products or product categories, which can result in different processing requirements and involvement of additional components of the architecture to complete the processing of the second service call. Alternatively or in addition, schedule lines can be attached to each items, for example if an order is to be split into separate shipments. Different software components may be triggered to process such a service call, thereby increasing the business value of the service call.

In some implementations of the current subject matter, business value can be considered from a system capabilities leveraging point of view rather than from a customer business process point of view. In other words, the calculated business value of a specific service call relates to processing and service call impact on system resources of the software architecture and/or other external service providers. For example, a sales order containing 1000 items in multiple different product categories and having a total shipped product value of $1000 would have a higher business value than a sales order containing one item and a total shipped product value of $200000.

Business value usage patterns can also be applied and analyzed with regard to outbound messages generated by a software architecture in response to a service call. Outbound information can be in the form of a data push in which information is actively sent to an external consumer, and a data pull in which information is passively sent to an external consumer (e.g. in direct response to a request). In a data pull, the architecture waits for a service call from an external consumer and provides the requested data. The main data flow for both aspects is an outbound flow. Both push and pull outbound data variants can be analyzed in a complementary manner to the above-noted patterns.

An example of pattern analysis for a data pull aspect can include analysis of sales order instances within an architecture. An interface for completing a sales order instance can be used by an external consumer. A first service call to this interface can include scanning for sales orders with an “open” status, while a second service call to this interface can include querying for a total amount of closed sales order in a specified period. Although the second service call might in some instances involve a smaller data volume than the first call, the calculated business value can be equal or even higher as the first service call due to a larger number of complex algorithms processed to answer the call.

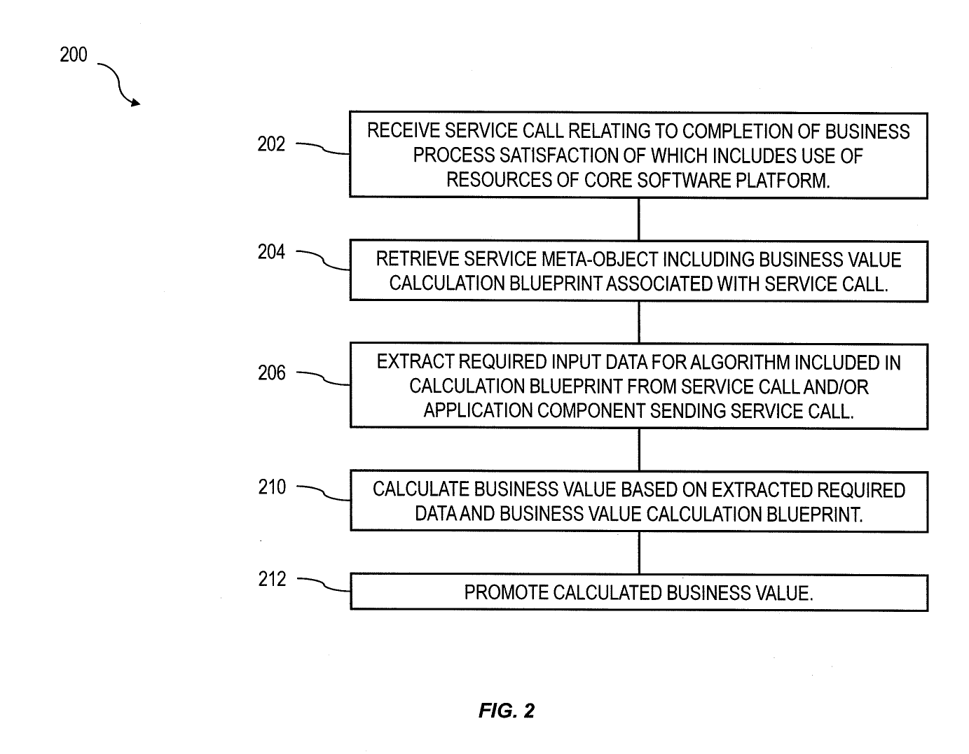

FIG. 2 shows a process flow chart 200 illustrating features of a method consistent with at least one implementation of the current subject matter. At 202, a service call relating to completion of a business process is received, for example at a core software platform. Satisfaction of the service call includes use of resources of the core software platform. At 204, a service meta-object that includes a business value calculation blueprint associated with the service call is retrieved from a metadata repository. The business value calculation blueprint includes an algorithm for assigning a business value to the service call. The algorithm includes a specification of required input data about the service call. The required input data are extracted at 206 from at least one of the service call and an application component from which the service call originated. At 210, the business value of the service call is calculated based on the extracted required data and the business value calculation blueprint. The calculated business value is promoted at 212.

Alternatively or in addition, the dynamic usage and invocation of core platform resources required to satisfy the service call can be documented and/or aggregated with similar data for all service calls. The service Meta-Object can also include a usage and logging blueprint to log data about the service call. The data to be logged can be defined in a flexible and in a declarative way using the service meta-object. The promoting can include one or more of generating and reporting an aggregated business value use rate by each tenant of the plurality of tenants based on the business value of the service call and the business value of all other service calls during a time period, using the collected information on dynamic system resource usage to improve capabilities of the system (e.g. by providing detailed feedback and conclusions about system usage) and/or optimize performance, and the like.

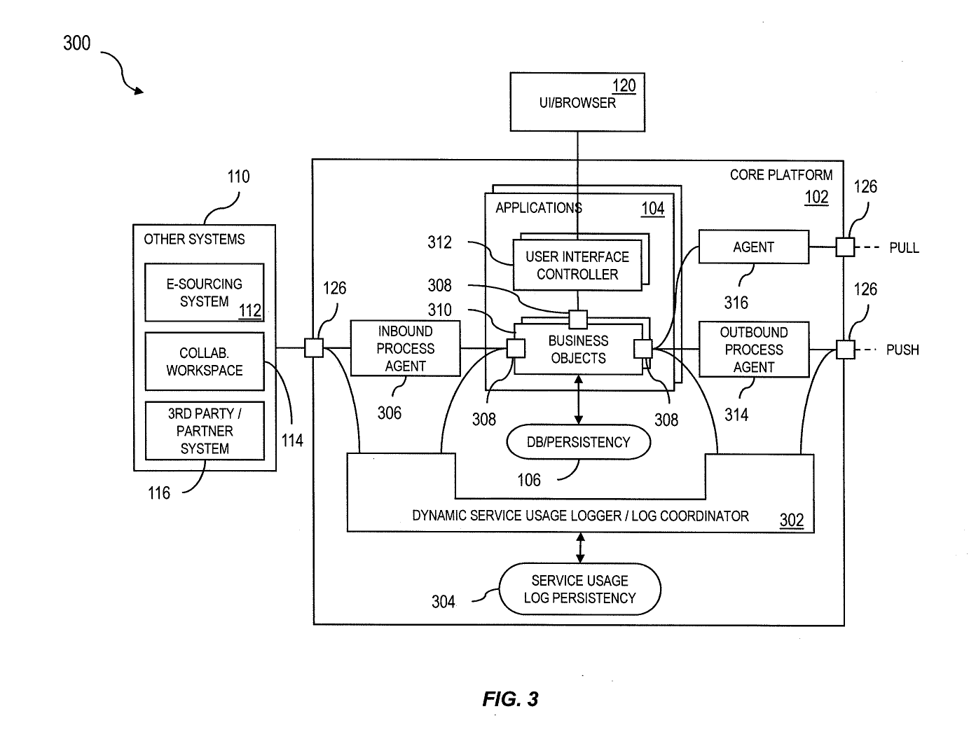

As shown in the diagram of a system architecture 300 shown in FIG. 3, data collection for patterns and variants can be performed by a dynamic service usage logger component 302 that interfaces with the runtime infrastructure and collects the measured information in a corresponding service usage log persistency 304. The dynamic service usage logger component 302 can be integrated into the main runtime infrastructures of the core platform 102 of a software architecture, such as for example a web service infrastructure and/or an enterprise services infrastructure for core business object services. With this integration, each service call, for example calls from other/external systems via a web services interface 126 that are processed by an inbound process agent 306, a call from a business object interface 308 of one or more business objects called by an application 104 of the core platform 102 using a business object engine 310 in response to user requests at a user interface or browser 120 received via a user interface controller 312, outbound data calls from an outbound process agent 314 (e.g. as a “push”) and other data agents 316 (e.g. as a “pull”) via other web service interfaces 126, and the like can be measured, filtered, and logged by the dynamic service usage logger component 302 to determine a business value usage. The dynamic service usage logger component 302 can be integrated into a software architecture in a generic manner that does not require application-specific development efforts.

The inbound process agent 306 and outbound process agent 314 can be part of a process agent framework, which in some implementations serves as a mediator between web services 126 and other services (e.g. the business object engine 310) of the core software platform 102 services. This process agent framework can serve as an integrator for inbound and outbound web service calls made via web services engines 126. If additional usage information is required, the process agent framework can also be integrated with the dynamic service usage logger component 302. With a logging infrastructure integrated into a main software architecture framework in place, main system usage information can be determined and persisted to serve as a basis for analyzing business value usage per customer, user, etc.

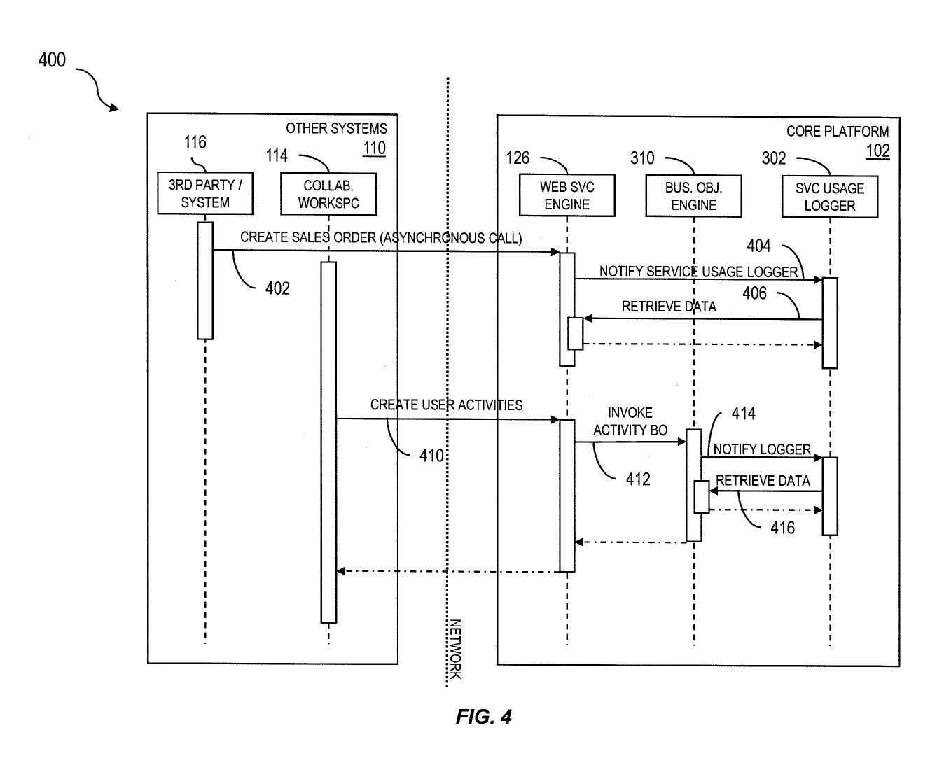

FIG. 4 shows a sequence diagram 400 showing information collection or usage-based patterns in illustrative business process. A third party system 116 can create a sales order at 402, for example as an asynchronous call to a web service engine 126 of a core platform 102 of a software architecture. The web service engine 126 can notify the dynamic service usage logger 302 at 404, which can in turn at 406 call the web service engine 126 to retrieve data about the service call. A collaboration workspace program 114 can create one or more user activities 410, also via a call to the web service engine 126. The web service engine can in turn invoke a business object at 412 via the business object engine 310. The business object engine 310 can notify the dynamic service usage logger 302 at 414, which can in turn at 416 call the business object engine 310 to retrieve data about the service call.

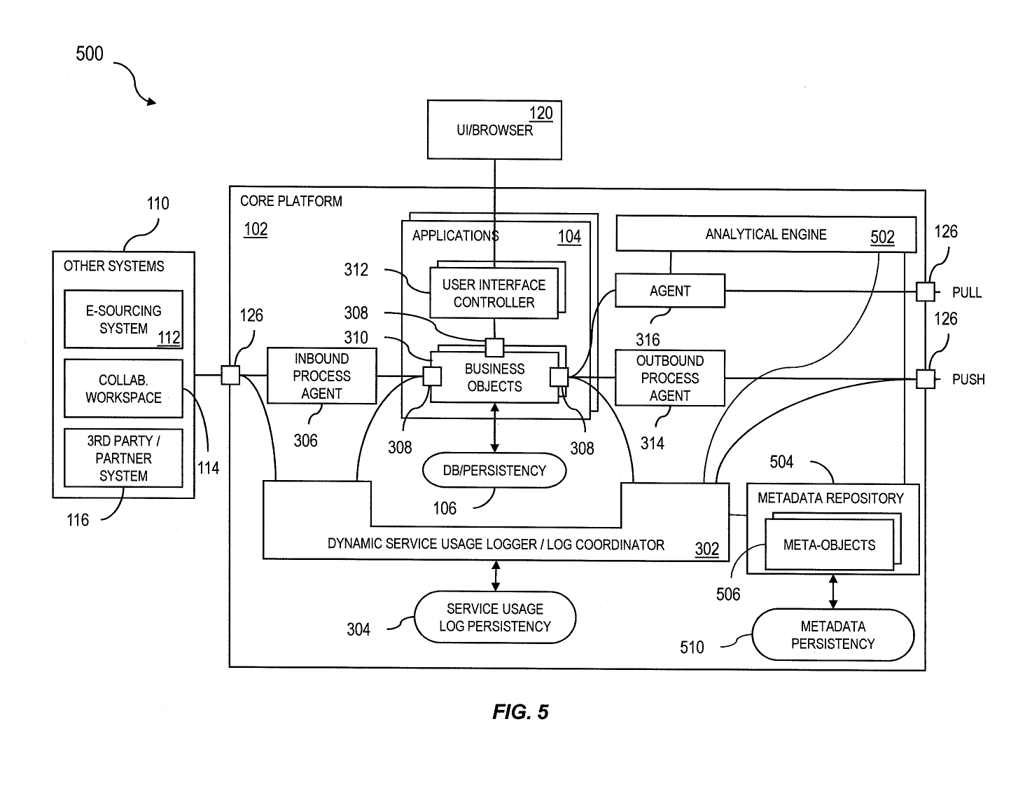

FIG. 5 shows a system architecture diagram 500 illustrating additional features that can be included in implementations of the current subject matter. The dynamic service usage logger component 302 can be integrated with an analytics run time engine 502 of the core platform 102, for example in a similar manner to the other run time engines such as the business object engine 310 and the web service engines 126. Such integration can enable support for analysis of the usage patterns as discussed herein. The analytics run time engine can include one or more of online analytical processing (OLAP) online transaction processing (OLTP) capabilities. The dynamic service usage logger component 302 can be enabled to analyze and understand the business semantic of a service invoked by a service call. The semantics can be provided using additional metadata related to the called service. For each type of service (e.g. the various run time engines mentioned herein) a service usage meta-object 504 can be defined in a metadata repository 506 and persisted via a metadata persistency 510. These meta-objects 504 can enable modeling business value calculation rules in a domain specific and in a declarative way.

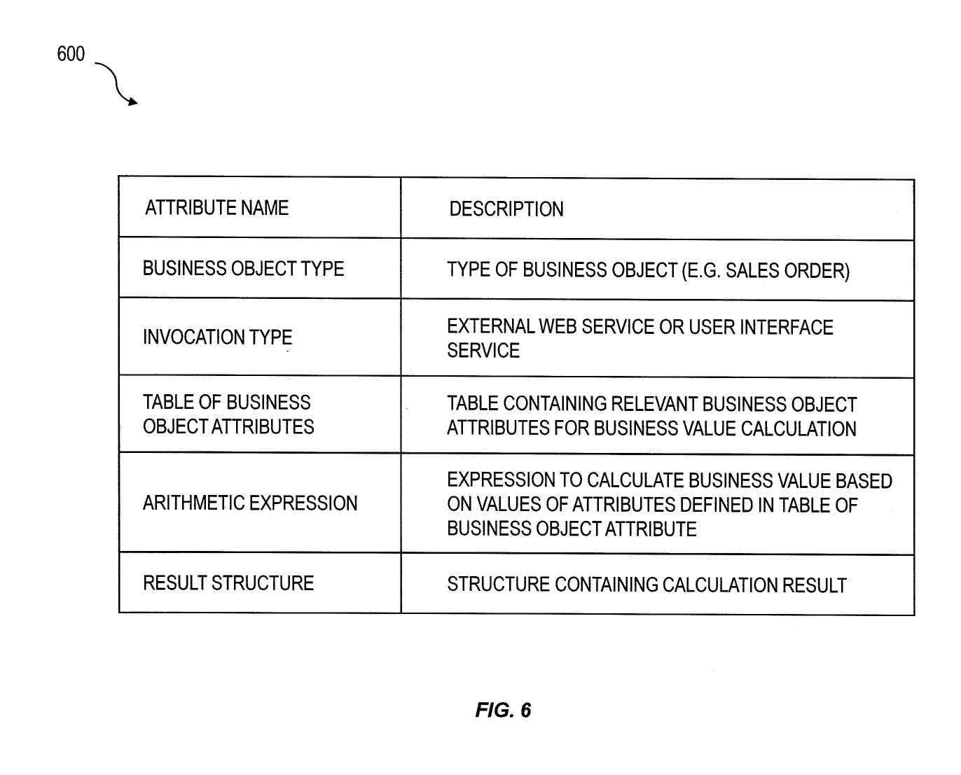

For each runtime engine, a specific service usage meta-data object 504 can be implemented to allow a business value calculation based on the semantics of the invoked service. For example, for the business object runtime engine 310, a business object service meta-object can contain one or more instances describing how the business value of a service invocation based on a business object can be calculated. FIG. 6 shows a table 600 illustrating examples of how such a business object service meta-object can be structured.

The absolute paths of the business object attributes can also be stored in such a table 600. Additionally, a transformation rule can be linked to the attribute in case the attribute is a calculated attribute and not a persisted one. Such information can be necessary for retrieval of the concrete attribute value of a concrete business object instance at runtime when the business value of a service usage business is calculated. This information can be provided by metadata repository 502.

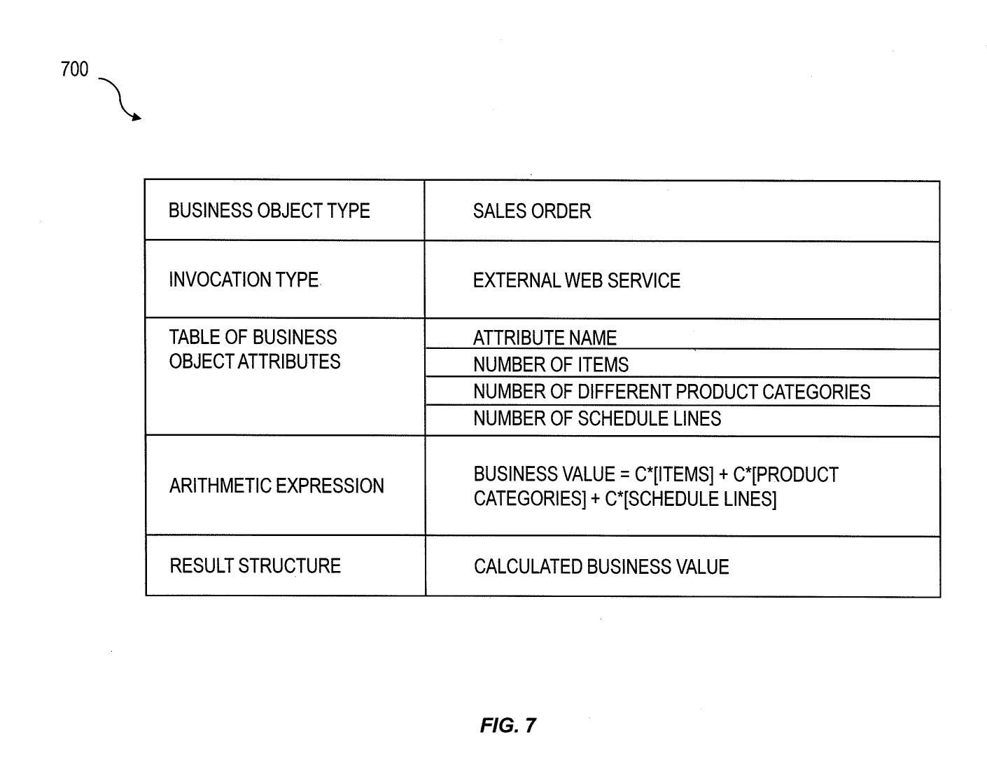

Returning to the example of sales order creation discussed above in regards to FIG. 4, calculation of the business value of a sales order creation via an external system can in some implementations be defined by creating a new instance (model) of the business service-usage meta-object 506 relating to service calls of this type. The new instance can be referred to as a sales order service usage instance. The business value of the service invocation can, for example, be derived based on a number of sales order items, a number of product categories, a number of schedule lines, and the like. The table 700 of FIG. 7 illustrates a meta-object structure for the sales order service usage instance of this example based on the generic structure shown in the table 600 of FIG. 6.

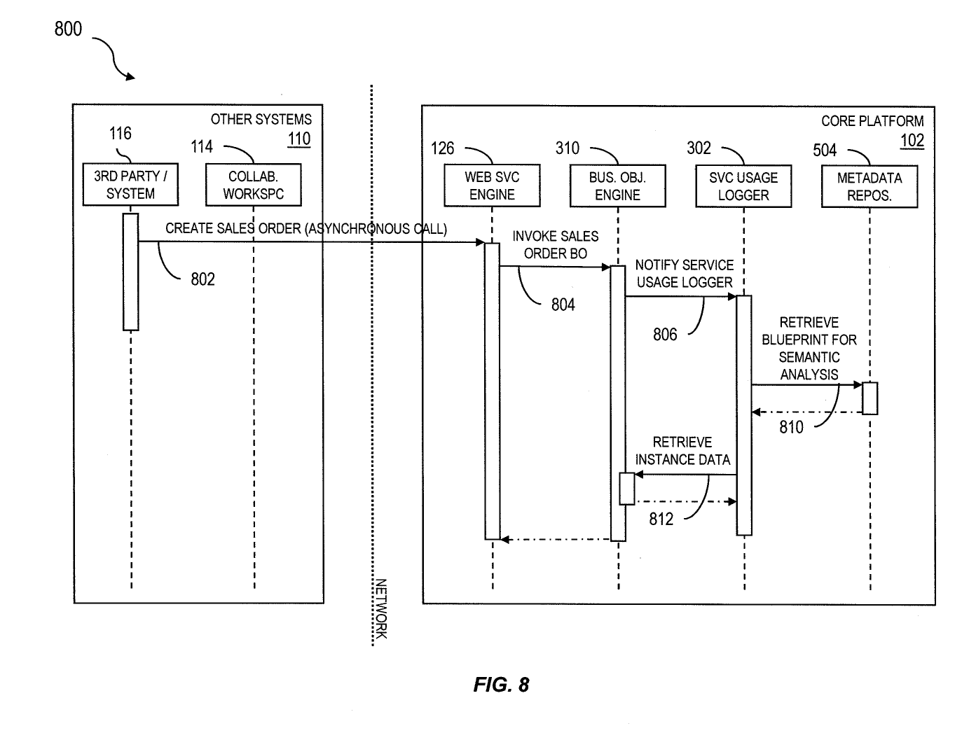

The call sequence diagram 800 of FIG. 8 illustrates an example of how business value can be calculated for the example of a sales order creation based on modeled service usage according to implementations of the current subject matter. As in FIG. 4, a third party system 116 can create a sales order at 802, for example as an asynchronous call to a web service engine 126 of a core platform 102 of a software architecture. The web service engine 126 can invoke the appropriate sales order business object by calling the business object engine 310 at 804. Once the business object engine 310 notifies the dynamic service usage logger component 302 at 806, the dynamic service usage logger component 302 accesses the metadata repository 504 at 810 to retrieve the appropriate meta-object depending on the invocation type. Based on the invoked service, the service-usage model can also be retrieved. The blueprint to calculate the business value of the service-usage is read from the retrieved model and the calculation is processed and logged by the dynamic service usage logger component 302 based on instance data retrieved from the business object engine 310 at 812.

Variations on the sequence shown in FIG. 8 are possible. For example, due to performance optimization, the dynamic service usage logger component 302 can be invoked asynchronously to decouple the service processing from the logging process. Additionally, the service-usage blueprints in the metadata repository 504 can be optimized and transformed in optimized runtime artifacts following the a metadata repository leveraging model.

Collected service-usage data can be retrieved in the same way as the core platform application and infrastructure data. Service-usage data can be exposed via end-user applications of the core platform 102, for example using a user interface provided via a browser 120. Once the embedded infrastructure for a dynamic service usage logger component 302 is available and data about usage is collected within the system, this infrastructure can be used in several ways to obtain information for the core platform provider. Since the infrastructure can fit natively into a core platform SaaS architecture, all capabilities that are available for applications provided by the core platform 102 can also be used by the dynamic service usage logger component 302. As an example, service interfaces can be used to read data from the core platform applications 104. The data can be used by the core platform provider to retrieve measurement data (e.g. periodically) into a separate analysis environment to analyze the data. The separate analysis environment can include one or more of online analytical processing (OLAP) online transaction processing (OLTP) capabilities.

Tools can also be built to evaluate the data collected according to implementations of the current subject matter across different core platform systems, architectures, individual system tenants, and the like to analyze the measurements and thereby obtain information about system usage in terms of used application functionality. Having this information in place, the core platform provider can gain valuable insight into the frequency of use by customers of functions and features. Based on this information, investment decisions for development cycles can be derived.

In addition to the analysis of system usage across customers, the information per customer can be used to realize alternative payment models. If customers are charged per system usage rather than per user, the different patterns and measurement information obtained via the current subject matter can be used to calculate the monthly fee for customers.

The approaches described herein can also be relevant in a business application platform scenario. A comprehensive on-demand business application development platform can be provided to offer powerful development and operation infrastructure and reusable business content. These key capabilities can enable development partners, community developers and internal development teams to build new applications on top of an existing core platform 102 in a short time and with less effort. Although the major business functionalities and features are provided by the core platform 102, those features and capabilities can be exposed to the end user via the applications built on top of the core platform 102. The approaches described herein can be used by those applications to collect information that provide the basis for different processes like software license tracking and pricing calculation as well as feedback on user behavior to enhance the software.

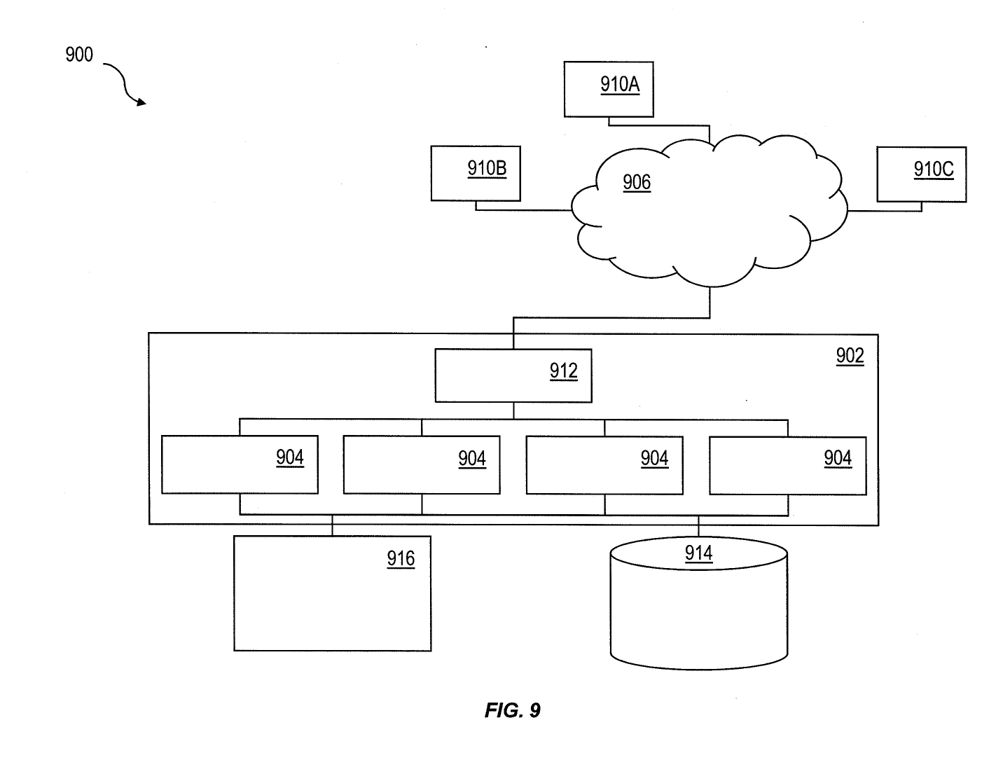

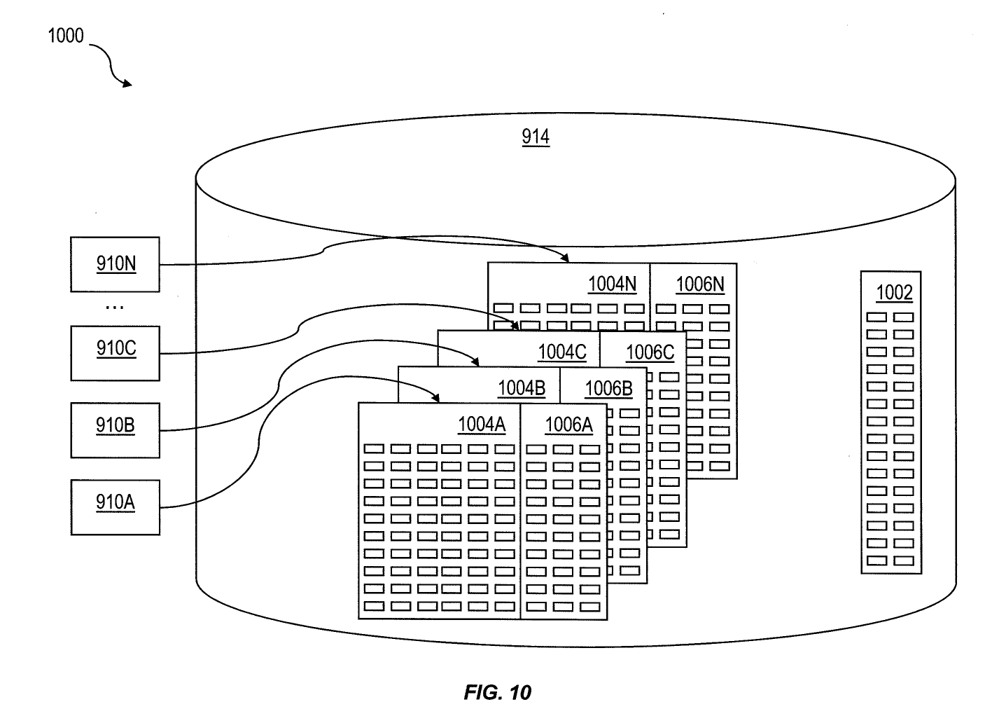

One example of an on-demand business software architecture that can implement aspects of the current subject matter is a multi-tenant software architecture, features of which are shown in FIG. 9 and FIG. 10. FIG. 9 shows a block diagram of a multi-tenant implementation of a software delivery architecture 900 that includes an application server 902, which can in some implementations include multiple server systems 904 that are accessible over a network 906 from client machines operated by users at each of multiple organizations 910A-910C (referred to herein as “tenants” of a multi-tenant system) supported by a single software delivery architecture 900. For a system in which the application server 902 includes multiple server systems 904, the application server can include a load balancer 912 to distribute requests and actions from users at the one or more organizations 910A-910C to the one or more server systems 904. A user can access the software delivery architecture across the network using a thin client, such as for example a web browser or the like, or other portal software running on a client machine. The application server 902 can access data and data objects stored in one or more data repositories 914. The application server 902 can also serve as a middleware component via which access is provided to one or more external software components 916, such as for example those discussed above.

To provide for customization of the core software platform for each of multiple organizations supported by a single software delivery architecture 900, the data and data objects stored in the repository or repositories 914 that are accessed by the application server 902 can include three types of content as shown in FIG. 10: core software platform content 1002, system content 1004, and tenant content 1006. Core software platform content 1002 includes content that represents core functionality and is not modifiable by a tenant. System content 1004 can in some examples be created by the runtime of the core software platform and can include core data objects that are modifiable with data provided by each tenant. For example, if the core software platform is an ERP system that includes inventory tracking functionality, the system content 1004A-1004N can include data objects for labeling and quantifying inventory. The data retained in these data objects are tenant-specific: for example, each tenant 910A-910N stores information about its own inventory. Tenant content 1006A-1006N includes data objects or extensions to other data objects that are customized for one specific tenant 910A-910N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 1006 can include condition records in generated condition tables, access sequences, price calculation results, or any other tenant-specific values. A combination of the software platform content 1002 and system content 1004 and tenant content 1006 of a specific tenant are presented to users from that tenant such that each tenant is provided access to a customized solution whose data are available only to users from that tenant.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 902 that includes multiple server systems 904 that handle processing loads distributed by a load balancer 912. Potential benefits from such an arrangement can include, but are not limited to, high and reliably continuous application server availability and minimization of unplanned downtime, phased updating of the multiple server systems 904 to permit continuous availability (one server system 904 can be taken offline while the other systems continue to provide services via the load balancer 912), scalability via addition or removal of a server system 904 that is accessed via the load balancer 912, and de-coupled lifecycle processes (such as for example system maintenance, software upgrades, etc.) that enable updating of the core software independently of tenant-specific customizations implemented by individual tenants.

Consistent with implementations of the current subject matter, the application server 902 can include a dynamic server logger component 302 as discussed above to log and analyze service calls originating from users at each of multiple tenants 910A-910N to provide a use-based subscription fee structure that sets pricing for each organization access to the core software platform and/or the external systems at least in part as a function of the business value of the service calls made by users via that organization's tenant.

Aspects of the subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. A client and server are generally, but not exclusively, remote from each other and typically interact through a communication network, although the components of the system can be interconnected by any form or medium of digital data communication. Examples of communication networks include, but are not limited to, a local area network (“LAN”), a wide area network (“WAN”), and the Internet. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed:

1. A computer program product comprising a machine-readable medium storing instructions that, when executed by at least one programmable processor, cause the at least one programmable processor to perform operations comprising:
receiving a service call relating to completion of a business process, satisfaction of the service call comprising use of resources of a core software platform;
retrieving, from a metadata repository, a service meta-object comprising a business value calculation blueprint associated with the service call, the business value calculation blueprint comprising an algorithm for assigning a business value to the service call, the algorithm comprising a specification of required input data about the service call;
extracting the required input data from at least one of the service call and an application component from which the service call originated;
calculating the business value based on the extracted required data and the business value calculation blueprint; and
promoting the calculated business value.

2. A computer program product as in claim 1, wherein the core software platform comprises a multi-tenant architecture comprising:
an application server providing access for each of a plurality of organizations to at least one of a plurality of client tenants, the client tenants each being configured to provide isolated access to a customizable instance of the core software platform; and
a data repository comprising core software platform content common to all of the plurality of client tenants and relating to operation of the core software platform, system content having a system content format defined by the core software platform and containing system content data that are unique to specific client tenants of the plurality of client tenants, and tenant-specific content items whose tenant-specific content formats and tenant-specific content data are defined by and available to only one of the plurality of client tenants.

3. A computer program product as in claim 2, wherein the service call is initiated by a tenant of the plurality of tenants; and the promoting comprises generating an aggregated business value use by the tenant by adding the business value of the service call to other business values of other service calls originating from the tenant during a billing period.

4. A computer program product as in claim 2, further comprising calculating a subscription price for the billing period to be paid by the organization for which the tenant provides isolated access to the customizable instance of the core software platform, the assigning comprising comparing the aggregated business value to a use-based subscription fee structure.

5. A computer program product as in claim 2, wherein the promoting comprises generating and reporting an aggregated business value use rate by each tenant of the plurality of tenants based on the business value of the service call and the business value of all other service calls during a time period.

6. A computer program product as in claim 5, wherein the application server comprises a plurality of server machines to which a plurality of incoming service calls from the plurality of tenants are distributed by a load balancer, and wherein the operations further comprise determining an algorithm for distributing the incoming service calls based on the aggregated business value use rate by each tenant of the plurality of tenants.

7. A computer program product as in claim 1, wherein the service meta-object further comprises a usage and logging blueprint defining usage data to log in regards to the service call; and
wherein the operations further comprise documenting dynamic usage and invocation of the resources of the core software platform in satisfying the service call.

8. A system comprising:
at least one processor; and
a machine-readable medium storing instructions that, when executed by the at least one programmable processor cause the at least one programmable processor to perform operations comprising:
receiving a service call relating to completion of a business process, satisfaction of the service call comprising use of resources of a core software platform;
retrieving, from a metadata repository, a service meta-object comprising a business value calculation blueprint associated with the service call, the business value calculation blueprint comprising an algorithm for assigning a business value to the service call, the algorithm comprising a specification of required input data about the service call;
extracting the required input data from at least one of the service call and an application component from which the service call originated;
calculating the business value based on the extracted required data and the business value calculation blueprint; and
promoting the calculated business value.

9. A system as in claim 8, wherein the core software platform comprises a multi-tenant architecture comprising:
an application server providing access for each of a plurality of organizations to at least one of a plurality of client tenants, the client tenants each being configured to provide isolated access to a customizable instance of the core software platform; and
a data repository comprising core software platform content common to all of the plurality of client tenants and relating to operation of the core software platform, system content having a system content format defined by the core software platform and containing system content data that are unique to specific client tenants of the plurality of client tenants, and tenant-specific content items whose tenant-specific content formats and tenant-specific content data are defined by and available to only one of the plurality of client tenants.

10. A system as in claim 9, wherein the service call is initiated by a tenant of the plurality of tenants; and the promoting comprises generating an aggregated business value use by the tenant by adding the business value of the service call to other business values of other service calls originating from the tenant during a billing period.

11. A system as in claim 9, further comprising calculating a subscription price for the billing period to be paid by the organization for which the tenant provides isolated access to the customizable instance of the core software platform, the assigning comprising comparing the aggregated business value to a use-based subscription fee structure.

12. A system as in claim 9, wherein the promoting comprises generating and reporting an aggregated business value use rate by each tenant of the plurality of tenants based on the business value of the service call and the business value of all other service calls during a time period.

13. A system as in claim 12, wherein the application server comprises a plurality of server machines to which a plurality of incoming service calls from the plurality of tenants are distributed by a load balancer, and wherein the operations further comprise determining an algorithm for distributing the incoming service calls based on the aggregated business value use rate by each tenant of the plurality of tenants.

14. A system as in claim 8, wherein the service meta-object further comprises a usage and logging blueprint defining usage data to log in regards to the service call; and
wherein the operations further comprise documenting dynamic usage and invocation of the resources of the core software platform in satisfying the service call.

15. A computer-implemented method comprising:
receiving a service call relating to completion of a business process, satisfaction of the service call comprising use of resources of a core software platform;
retrieving, from a metadata repository, a service meta-object comprising a business value calculation blueprint associated with the service call, the business value calculation blueprint comprising an algorithm for assigning a business value to the service call, the algorithm comprising a specification of required input data about the service call;
extracting the required input data from at least one of the service call and an application component from which the service call originated;
calculating the business value based on the extracted required data and the business value calculation blueprint; and
promoting the calculated business value.

16. A computer-implemented method as in claim 15, wherein the core software platform comprises a multi-tenant architecture comprising:
an application server providing access for each of a plurality of organizations to at least one of a plurality of client tenants, the client tenants each being configured to provide isolated access to a customizable instance of the core software platform; and
a data repository comprising core software platform content common to all of the plurality of client tenants and relating to operation of the core software platform, system content having a system content format defined by the core software platform and containing system content data that are unique to specific client tenants of the plurality of client tenants, and tenant-specific content items whose tenant-specific content formats and tenant-specific content data are defined by and available to only one of the plurality of client tenants.

17. A computer-implemented method as in claim 16, wherein the service call is initiated by a tenant of the plurality of tenants; and the promoting comprises generating an aggregated business value use by the tenant by adding the business value of the service call to other business values of other service calls originating from the tenant during a billing period.

18. A computer-implemented method as in claim 16, further comprising calculating a subscription price for the billing period to be paid by the organization for which the tenant provides isolated access to the customizable instance of the core software platform, the assigning comprising comparing the aggregated business value to a use-based subscription fee structure.

19. A computer-implemented method as in claim 16, wherein the promoting comprises generating and reporting an aggregated business value use rate by each tenant of the plurality of tenants based on the business value of the service call and the business value of all other service calls during a time period.

20. A computer-implemented method as in claim 15, wherein at least one of the receiving, the retrieving, the extracting, the calculating, and the promoting are performed by at least one processor.
